(19) United States
(12) Patent Application Publication
(10) Pub. No.: US 2026/0328893 A1
(43) Pub. Date: Oct. 22, 2026

(54) GEOLOCATION SYSTEM AND METHOD USING LIGHTNING AND MAN-MADE BEACONS

(71) Applicant: Keraunos Systems, Inc., Centerville, MA (US)

(72) Inventors: Thomas R. Willemain, Belmont, MA (US); Nelson Seth Hartunian, Belmont, MA (US); Brock Estel Osborn, Huntersville, NC (US); James Richard Hendershot, Grants Pass, OR (US)

(21) Appl. No.: 19/649,248

(22) Filed: Apr. 16, 2026

Related U.S. Application Data
(60) Provisional application No. 63/790,112, filed on Apr. 17, 2025.
(60) Provisional application No. 63/890,418, filed on Sep. 30, 2025.

(51) Int. Cl. G01S 5/16; G01S 5/00

(52) U.S. Cl. CPC G01S 5/16; G01S 5/0036; G01S 5/009

(57) ABSTRACT

A geolocation system and method. The system includes: a receiver coupled to an antenna and configured to receive electromagnetic (EM) signals; a system for recommending at least one frequency to monitor; a detection system for detecting a target signal from the EM signals consisting of a lightning stroke or a manmade beacon based on at least one frequency; a system for determining first time of arrival (TOA) information for the target signal; a transceiver for receiving second TOA information from a remote mobile unit; a geolocation algorithm that calculates time difference of arrival (TDOA) information from the first TOA information and second TOA information and generates geolocation results of the remote mobile unit based on the TDOA information.

### PRIORITY

This application claims priority to co-pending provisional application Ser. No. 63/790,112, SYSTEM AND METHOD FOR GEOLOCATION USING LIGHTNING, filed on Apr. 17, 2025, and Ser. No. 63/890,418, METHOD AND APPARATUS FOR GEOLOCATION UTILIZING LIGHTNING AND A GEOMETRICALLY BALANCED ARRAY OF RECEIVERS, filed on Sep. 30, 2025, the contents of which are hereby incorporated by reference.

### TECHNICAL FIELD

The subject matter of this disclosure relates to an alternative to GPS as a means to geolocate mobile units, and more particularly relates to a system and method that utilizes lighting strokes and other forms of electromagnetic radiation for geolocation.

### BACKGROUND

The Global Positioning System (GPS) is a network of satellites that provides location, navigation, and timing information. GPS is used in many devices, including smartphones, cars, and watches. Mobile units that require geolocation may for example include disaster response teams, wilderness search and rescue squads, Coast Guard and NOAA vessels, etc.

### SUMMARY

Aspects of the disclosure provide an alternative to GPS as a means to geolocate mobile units, including ships, land vehicles and air vehicles. In various aspects, the systems and method can exploit naturally occurring electromagnetic (EM) signals such as lightning and manmade EM signals (i.e., beacons) such as radio broadcasts.

In a first aspect, a geolocation system for a local mobile unit is provided, comprising: a receiver coupled to an antenna and configured to receive electromagnetic (EM) signals; a system for recommending at least one frequency to monitor; a detection system for detecting a lightning stroke from the EM signals based on the at least one frequency; a system for determining local time of arrival (TOA) information for the lightning stroke; a transceiver for receiving remote TOA information from a remote mobile unit; and a geolocation algorithm that calculates time difference of arrival (TDOA) information from the local TOA information and remote TOA information and generates geolocation results of the remote mobile unit based on the TDOA information.

In a further aspect, the detection system is configured to detect man-made beacons and the system for determining local TOA information determines TOA information for the man-made beacon.

In another aspect, a method for determining a location of a remote mobile unit from a local mobile unit is provided, comprising: recommending at least one frequency to monitor; monitoring electromagnetic (EM) signals at the at least one frequency with a receiver coupled to an antenna; detecting a lightning stroke from the EM signals based on the at least one frequency; determining local time of arrival (TOA) information for the lightning stroke; receiving remote TOA information for the lightning stroke from the remote mobile unit; and calculating time difference of arrival (TDOA) information from the local TOA information and remote TOA information and generating geolocation results of the remote mobile unit based on the TDOA information.

In a further aspect, the method includes: providing a selector to detect a man-made beacon; determining local TOA information from the man-made beacon; receiving remote TOA information; and calculating time difference of arrival (TDOA) information from the local TOA information and remote TOA information and generating geolocation results of the remote mobile unit based on the TDOA information.

Other aspects include any one of the aspects and wherein the antenna comprises a directional antenna that provides directional information; and/or wherein the system for determining local TOA information utilizes an Oven Controlled Crystal Oscillator (OCXO) clock.

In certain aspects the geolocation algorithm determines a relative location of the remote mobile unit and is implemented according to a process that includes: obtaining TOA information for two lightning strokes at both a local mobile unit and a remote mobile unit, wherein the TOA information includes directional information for each lightning stroke; calculating TDOA information for both lightning strokes; choosing distance values from the local mobile unit to each of the two lightning strokes; estimating a location of each lightning stroke based on the distance values and directional information; constructing a pair of circles around estimated locations of the two lightning strokes; determining an estimated location of the second mobile unit based on the intersection of the pair of circles; and revising the distance values and repeating the estimating, constructing, determining steps until a converged solution is obtained.

In other aspects, the geolocation algorithm determines a location of the remote mobile unit and is implemented according to a parallax process that includes: training a model on simulated scenarios of lightning storms, wherein the model is trained with parallax estimates for each simulated scenario; obtaining TOA information; computing TDOA information from the TOA information; converting TDOA information to distance estimates; and correcting the distance measurements with the model to generate a distance from the local mobile unit to the remote mobile unit.

In still other aspects, the detection system for detecting a lightning stroke is implemented according to process that includes calculating a signal strength threshold and detecting a lightning stroke for a captured signal above the signal strength threshold.

Various other aspects include: wherein the receiver coupled to the antenna comprises a very low frequency (VLF) receiver and VLF antenna; and/or the transceiver comprises a high frequency (HF) transceiver coupled to a HF antenna.

In certain aspects, the system and method may include a pair of spaced antennas, each configured to obtain an intra-unit TOA; a system for calculating an intra-unit TDOA (ITDOA) from the pair of intra-unit TOAs; and a system for determining directional data from the ITDOA.

Other aspects may provide: wherein the system or method for recommending at least one frequency to monitor includes a frequency scanner; the system or method further comprises a selector system for selecting between using lightning strokes and man-made beacons; the system or method further comprises a beacon database that includes beacon transmitter information; and/or the system or method comprises a subsystem that uses TOA information from man-made beacons to triangulate an absolute location of the local mobile unit.

It is understood that any of the above aspects may be combined with any one or more of the other aspects.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a geolocation system according to embodiments.

FIG. 2 shows a flow diagram of a method of implementing a geolocation system according to embodiments.

FIG. 3 shows a grid with mobile units and lightning strokes according to embodiments.

FIG. 4 shows a grid of FIG. 3 with directional information used in a geolocation algorithm according to embodiments.

FIG. 5 shows an expanded view of the grid of FIG. 3 with intersecting circles to geolocate a mobile unit according to embodiments.

FIG. 6 shows use cases of mobile units detecting lightning strokes according to embodiments.

FIG. 7 shows a simulation of mobile units and lightning strokes according to embodiments.

FIG. 8 shows tables of estimates generating using a parallax method according to embodiments.

FIG. 9 shows an interface depicting manmade and lighting signals according to embodiments.

FIG. 10 shows plots for calculating a signal detection threshold according to embodiments.

FIG. 11 shows an interface that illustrates how signals are detected, according to embodiments.

FIG. 12 shows a table of results for accuracy in detecting signals according to embodiments.

FIG. 13 shows a mobile unit with TDOA information according to embodiments.

FIG. 14 shows triangulation simulation information according to embodiments.

FIG. 15 shows various functionalities performed by a selector shown in FIG. 1 according to embodiments.

FIG. 16 shows an illustrative flow diagram of a geolocation system that can perform both relative positioning and absolute positioning of mobile units according to embodiments.

FIG. 17 shows a computing system according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Aspects of the present invention provide technical solutions for geolocating mobile units without using GPS. In one aspect, a system and method are provided that provide geolocation based on detected lightning strokes. Lightning creates electromagnetic (EM) pulses that travel at the speed of light. In the present approach, mobile units at different distances from a stroke detect the stroke at correspondingly different times. The time differences correlate with inter-unit distances that are utilized to geolocate mobile units. In other approaches, the detection of manmade EM signals (i.e., beacons) can be incorporated as a supplement or alternative to lightning strokes to geolocate mobile units

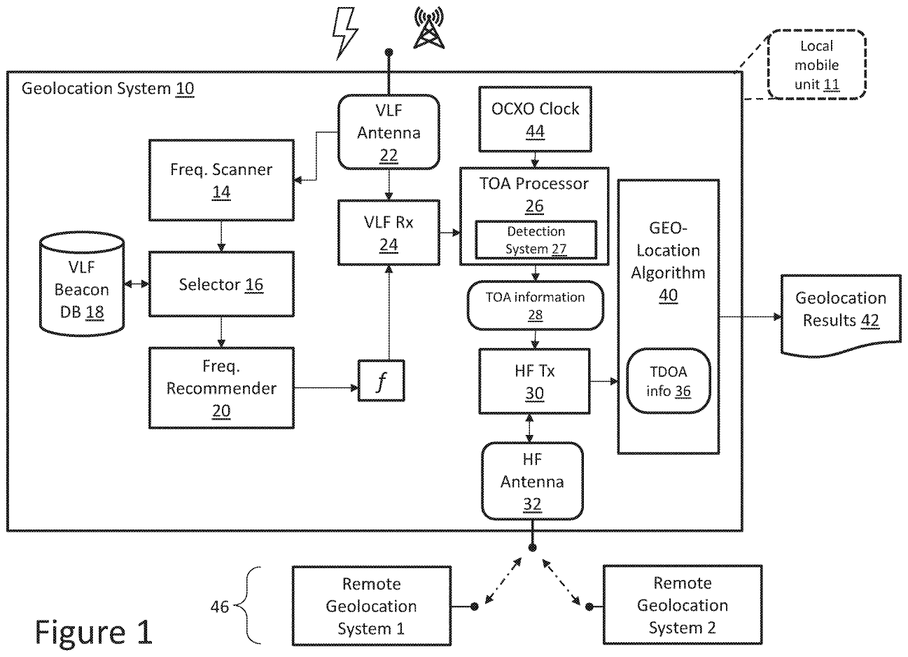

FIG. 1 depicts an illustrative geolocation system 10 installed in a local mobile unit 11 (e.g., a ship, a land vehicle, an air vehicle, etc.) to generate geolocation results 42. In this example, geolocation system 10 interacts with one or more other remote geolocation systems 1 and 2 (implemented on other mobile units 46) to provide geolocation results 42. In certain aspects, geolocation results 42 include a relative position of one more remote mobile units 46, i.e., their position relative to local mobile unit 11. In other aspects, geolocation results 42 include an absolute position of one more remote mobile units 10, 46 (i.e., latitude and longitude information). Each geolocation system includes equipment to detect EM signals (i.e., lightning strokes or manmade beacons) and capture corresponding time of arrival (TOA) information 28. TOA is the time the signal is detected at the mobile unit. The differences in local and remote TOA information among the different mobile units (referred to herein as the time difference of arrival (TDOA)) is then used to generate the geolocation results 42. In certain aspects the TOA information 28 and TDOA information 36 include directional information θ, which provides angular details regarding the direction of where the signal was generated.

As shown, geolocation system 10 of FIG. 1 is equipped to detect and utilize both lightning strokes and manmade beacons. However, it is understood that in other embodiments, geolocation system 10 may be implemented that only utilizes one of lightning strokes or manmade beacons.

Geolocation system 10 includes a frequency recommender 20 that effectively looks for one or more frequencies f best suited to capture lightning strokes or manmade beacons. In this illustrative embodiment, f is determined with a frequency scanner 14 coupled to an antenna, in this case a very low frequency (VLF) antenna 22, that continuously scans an associated frequency range (e.g., 3 to 30 kHz). Selector 16 determines an optimal frequency or set of frequencies that are, e.g., free of noise and interference. For example, bad candidate frequencies may include frequencies having random broadcasts or frequencies experiencing high levels of noise. Conversely, good candidate frequencies may for example include quiet frequencies with low detected activity.

In this embodiment, selector 16 can also determine whether to use lightning stroke data or beacon data. Beacon data may, for example, comprise periodic transmissions from a transmission site at a known fixed location (e.g., a radio tower). A VLF beacon database (DB) 18 may include a table of known transmission sites and their transmission schedules. In certain cases, it may be more effective to use lightning stroke data and in other cases use beacon date. Selector 16 may include any algorithm or logic to make such a determination. For example, selector 16 may interrogate VLF beacon database 18 to identify potential beacon signals. Based on a general location of a mobile unit or time of day, potential beacon signals may or may not be available or be too weak. In the case where no beacon signal is available, lightning activity can be used.

Regardless, a frequency recommender 20 outputs a frequency or set of frequencies f to VLF receiver (Rx) 24, which is then tuned accordingly to listen for signals collected from VLF antenna 22. VLF receiver 24 interacts with a TOA processor 26 to detect relevant signals (lightning or beacon) using detection system 27 and ascertains a time or arrival (i.e., TOA 28) of a received signal. In one embodiment, TOA processor 26 utilizes an OCXO (Oven Controlled Crystal Oscillator) clock 44, which is exactly synchronized with other OCXO clocks on the other geolocation systems. An OCXO clock is a high-precision electronic timing device that uses a temperature-controlled oven to maintain a quartz crystal at a constant, optimal temperature and therefore at a stable frequency

In certain embodiments, VLF antenna 22 comprises a directional antenna that provides directional information θ associated with the direction of the received signal (e.g., an angle relative to north).

Once the TOA of one or more signals is determined by TOA processor, the local TOA information 28 (which may include directional information θ) is shared with other remote mobile units 46 (and vice versa) via, e.g., a high frequency (HF) transceiver Tx 30 and HF antenna 32. The HV transceiver 30 collects the incoming remote TOA information from the remote geolocation systems for a detected common signal or signals. The local and remote TOA information is then used by geolocation algorithm 40 (or some other component) to generate time difference of arrival (TDOA) information 36. TDOA information 36 (which may include directional information θ) is then processed by a geolocation algorithm 40 to generate geolocation results 42.

In one illustrative embodiment, the process of generating TDOA information 36 among mobile units is essentially the same whether lightning or beacon data is utilized. Namely, TOA information 28 is determined for a set of received lightning or beacon signals, and the TOA 28 information is then compared with other TOA information collected from remote mobile units 46 to calculate TDOA information 36. Various approaches to exploiting TDOA information 36 are described in further detail herein.

It is understood that the geolocation system 10 described in FIG. 1 is not intended to be limiting. In other embodiments, different types of clocks (such as a rubidium atomic clock), communication systems/frequencies, etc., may be utilized. Additionally, different types of antennas and receivers, which operate on different frequencies, may be utilized.

In order to generate geolocation results 42, various technical challenges must be addressed, including providing a detection system 27 that can detect a lightning stroke (or beacon) and a geolocation algorithm 42 that can calculate geolocation results 42 from TDOA information 36.

### Geolocation Algorithm

### 1. Embodiment A

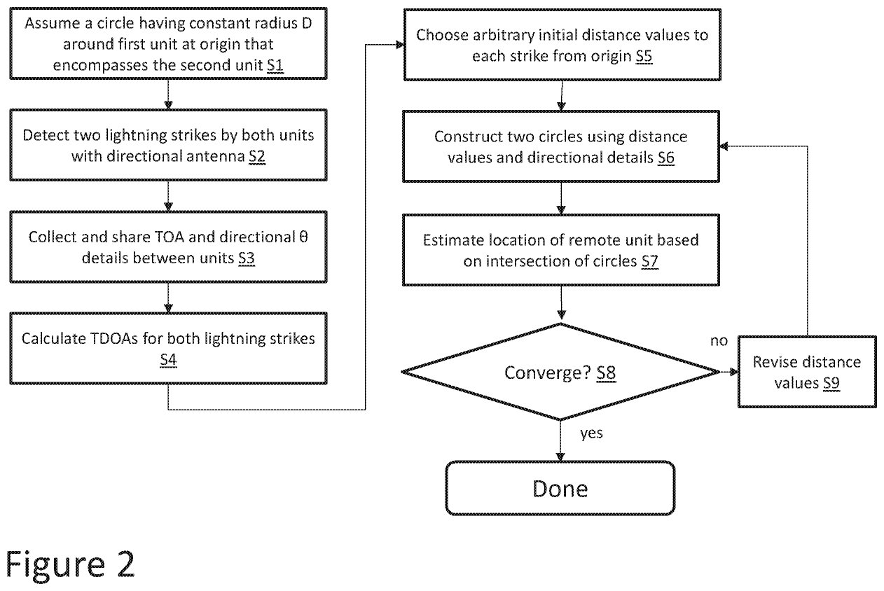

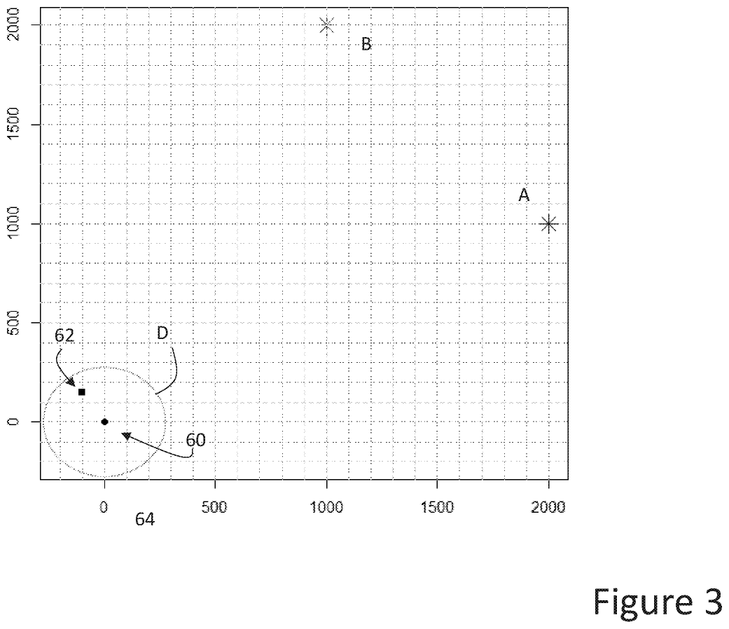

FIG. 2 depicts a flow diagram showing an illustrative process for implementing a geolocation algorithm 40 to generate geolocation results 42 from TDOA information 36, the details of which are described with reference to FIGS. 3-5. FIG. 3 depicts a grid showing two mobile units 60, 62, each of which includes the geolocation system 10 of FIG. 1, and includes a directional antenna for generating directional information θ. Local unit 60 is located at (U₀ₓ, U_{0y})=(0,0), which is defined to be the origin, and a remote unit K 62 is located at an unknown location, (U_{Kx}, U_{Ky}) K=1, . . . , n.

At S1 (FIG. 2), assume that there is some constant D such that \sqrt{U_{Kx}²+U_{Ky}²}<D for all K>0, i.e., D is a circle centered at local unit 60 that encompasses remote unit 62). The following approach determines the location of remote unit 62 (U_{Kx}, U_{Ky}), i.e., the relative position of unit 62 respect to the origin or local unit 60.

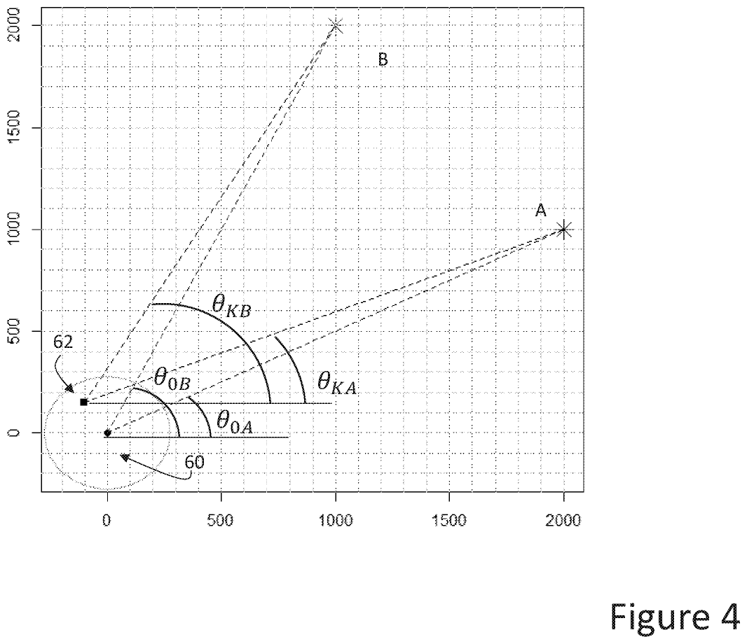

At S2, each unit 60, 62 listens and detects at least two lightning strokes (or other sources of EM signals that are to be used for geolocation), A and B, with directional antennas. Strokes A and B are much further away (e.g., at least five times) from (0,0) than D. At S3, TOA information is collected and at S4, TDOA information is calculated for both strokes A and B. An example is shown in FIG. 4 in which directional information θ_{OA} and θ_{OB} provides the angle of strokes A and B relative to local unit 60 at (0,0), and directional information θ_{KA} and θ_{KB} provides the angle of strokes A and B relative to remote unit K 62 at (U_{Kx}, U_{Ky}). Further δ_{KA} is the computed time difference of arrival (TDOA) of the signal for stroke A to reach the remote unit 62 (U_{Kx}, U_{Ky}) versus the local unit 60 (U₀ₓ, U_{0y}) and δ_{KB} is the corresponding time difference of arrival (TDOA) for stroke B. The TDOA values are converted into distance traveled differences (i.e., how much farther a given signal traveled to reach local unit 60 versus remote unit 62) as Δ_{KA}=(speed of light)×δ_{KA} and Δ_{KB}=(speed of light)×δ_{KB}.

The following algorithm determines the location of unit 62, i.e., the values of (U_{Kx}, U_{Ky}) given the quantities: θ_{KA}, θ_{KB}, Δ_{KA} and Δ_{KA}.

(1) At S5, choose arbitrary initial distance values for r_{A} and r_{B}, which are rough estimates of the distances from the origin (0,0) to strokes A and B. The distance values and directional information provide an estimated location for strokes A and B.
(2) At S6, construct two circles around the estimated locations of stroke A and stroke B using the values for r_{A} and r_{B} and θ_{KA} and θ_{KB}:
Circle 1 is centered at (θ_{OA}, r_{A}) in polar coordinates and has radius R_{KA}=r_{A}+Δ_{KA}.
Circle 2 is centered at (θ_{OB}, r_{B}) in polar coordinates and has radius R_{KB} r_{B}+Δ_{KB}.
   (3) At S7, determine an estimated location of the remote unit 62 (U_{Kx}, U_{Ky}) from the intersection of these two circles from the following algorithm:
   Define: H=r_{B} cos(θ_{OB})−r_{A} cos(θ_{OA}), L=r_{B} sin(θ_{OB})−r_{A} sin(θ_{OA}), ε=0.000001
   Case I: abs(H)<ε and abs(L)<ε

No point of intersection—strokes at the same location

Case II: abs(H)>ε and abs(L)>ε

$$α = \frac{{R}_{{KA}^{2}} - {R}_{{KB}^{2}} + {H}^{2} + {L}^{2}}{2 L} , β = \frac{H}{L}$$

then if α²β²−(1+β²)(α²−R_{KA}²)>0:

$${x}_{1} = \frac{αβ + \sqrt{{α}^{2} {β}^{2} - ( 1 + {β}^{2} ) ( {α}^{2} - {R}_{KA}^{2} )}}{1 + {β}^{2}} , \\ {x}_{2} = \frac{αβ - \sqrt{{α}^{2} {β}^{2} - ( 1 + {β}^{2} ) ( {α}^{2} - {R}_{KA}^{2} )}}{1 + {β}^{2}} , \\ {y}_{1} = α - β {x}_{1} , \\ {y}_{2} = α - β {x}_{2}$$

Case III: abs(H)<ε and abs(L)>ε

$${y}_{1} = \frac{{R}_{KA}^{2} - {R}_{KB}^{2} + {L}^{2}}{2 L} , \\ {y}_{2} = {y}_{1} , \\ {x}_{1} = \sqrt{{R}_{KA}^{2} - {y}_{1}^{2}} , \\ {x}_{2} = - {x}_{1}$$

Case IV: abs(H)>ε and abs(L)<ε

$${x}_{1} = \frac{{R}_{KA}^{2} - {R}_{KB}^{2} + {H}^{2}}{2 H} , \\ {x}_{2} = {x}_{1} , \\ {y}_{1} = \sqrt{{R}_{KA}^{2} - {x}_{1}^{2}} , \\ {y}_{2} = - {y}_{1}$$

The two possible points of intersection for these two circles are:

(μₓ,μ_{y})=(x₁+r_{A} cos(θ_{0A}),y₁+r_{A} sin(θ_{0A}))

(μₓ,μ_{y})=(x₂+r_{A} cos(θ_{0A}),y₂+r_{A} sin(θ_{0A}))

Choose the solution that meets the criterion: \sqrt{μₓ²+μ_{y}²}<D as the estimate for (U_{Kx}, U_{Ky}).
(5) At S8, check to see if the estimate (U_{Kx}, U_{Ky}) converges, i.e., did the estimated location with the current distance values significantly change from the estimated location with the previous distance values. Obviously, there will be no convergence on the initial pass.
(6) At S9, revise r_{A} and r_{B} based on this estimate:

b_{A}=U_{Ky}−U_{Kx} tan(θ_{KA}) b_{B}=U_{Ky}−U_{Kx} tan(θ_{KB})

$${x}_{A} = \frac{{b}_{A}}{tan ( {θ}_{0 A} ) - tan ( {θ}_{KA} )} \\ {x}_{B} = \frac{{b}_{B}}{tan ( {θ}_{0 B} ) - tan ( {θ}_{KB} )} \\ {y}_{A} = {x}_{A} tan ( {θ}_{0 A} ) \\ {y}_{B} = {x}_{B} tan ( {θ}_{0 B} ) \\ {r}_{A} = \sqrt{{x}_{A}^{2} + {y}_{A}^{2}} \\ {r}_{B} = \sqrt{{x}_{B}^{2} + {y}_{B}^{2}}$$

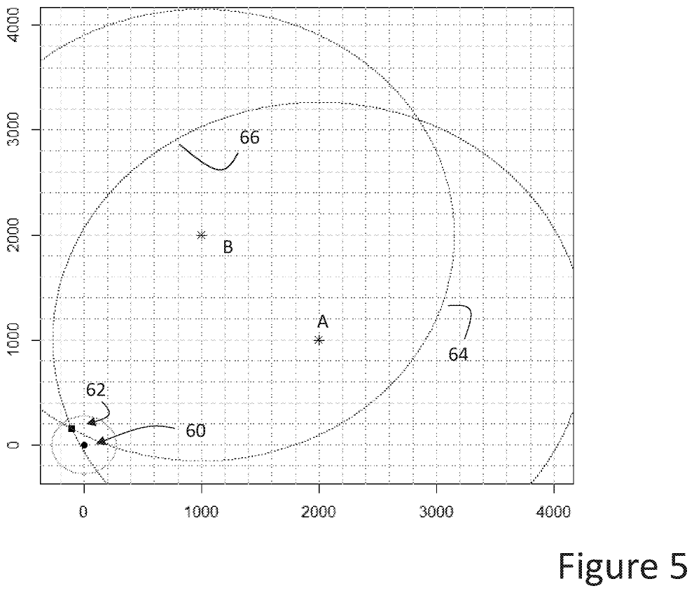

If no, revise estimated distances again and repeat the steps from S6 until the solution converges at S8. FIG. 5 depicts the converged result. As can be seen, circle 64 and circle 66 intersect at the location of unit 62.

### 2. Embodiment B

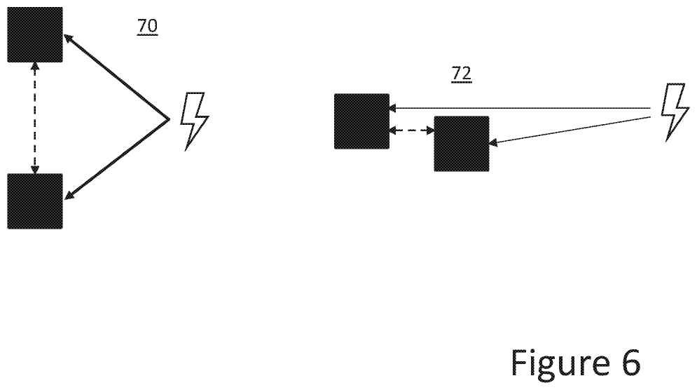

A further approach for generating geolocation results 42 based on TDOA information utilizes a parallax method as follows. Relative location puts the local unit at an imagined grid location of (0,0) and locates remote units relative to the first. The parallax method of relative location exploits the parallax provided by multiple electrical storms situated at different angles to the formation of units. FIG. 6 illustrates the relationship between parallax and the estimation of distance between two units. In the left example 70 of the figure, the stroke is located at 90 degrees from the axis between the units (designated by black squares). Lightning striking at this midpoint location would create signals that arrive simultaneously at both units, so their time difference of arrival (TDOA) would be zero, incorrectly implying no distance between the units. On the other hand, the right example 72 would create a TDOA that implies an almost perfect estimate of the inter-unit distance.

In most circumstances, there will be multiple active storms providing numerous TDOA estimates. A starting point for estimating the inter-unit distance is the naïve estimate, which is the largest observed TDOA value multiplied by the speed of light. This estimate is asymptotically accurate as the number of lightning strokes increases, but all the TDOA values used in the parallax method, including the largest, are biased low. However, machine learning methods trained on a large number of simulated scenarios can be used to adjust for the bias and produce enhanced parallax estimates (described below) that are unbiased and precise.

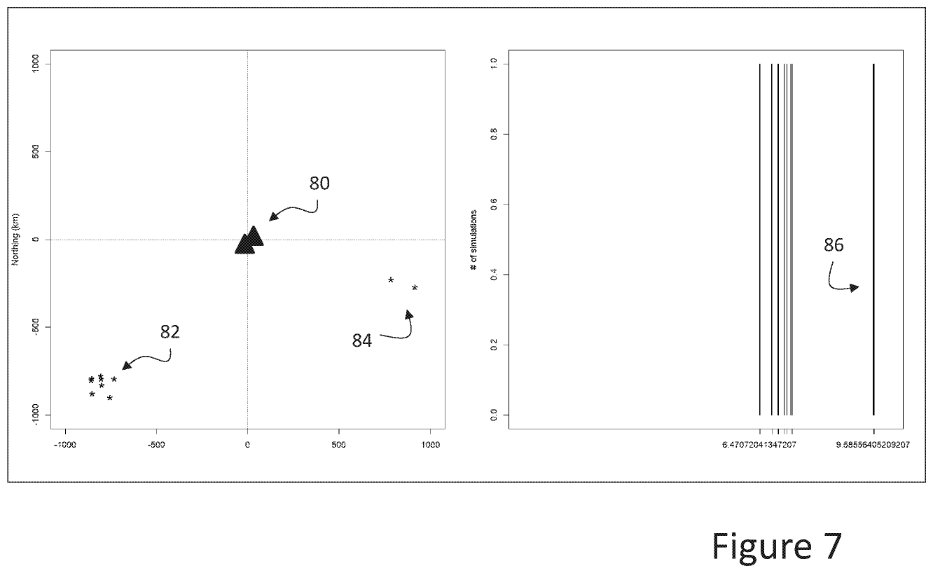

The left panel of FIG. 7 depicts a simulated scenario in which there are two mobile units 90 separated by 10 kilometers (shown as triangles in the left plot) and two distant electrical storms that have generated 10 strokes. The right panel shows the 10 estimates of unit separation computed by multiplying the 10 TDOA values by the speed of light. The largest estimate 86 is 9.6 kilometers, about 400 meters low. This downward bias is alleviated when more storms are active and there are more strokes per storm, so in many practical circumstances the basic parallax method can itself provide useful estimates of the distance between units.

The basic estimates can be greatly improved using machine learning methods. Certain summary statistics describing the distribution of the naïve parallax estimates (e.g., the standard deviation of TDOAs) provide the inputs to a type of machine learning algorithm called a random forest that approximates the downward bias in the basic estimate and then corrects for it. For instance, if an estimate falls at 50% of the true distance, multiplying the estimate by 2 corrects the bias.

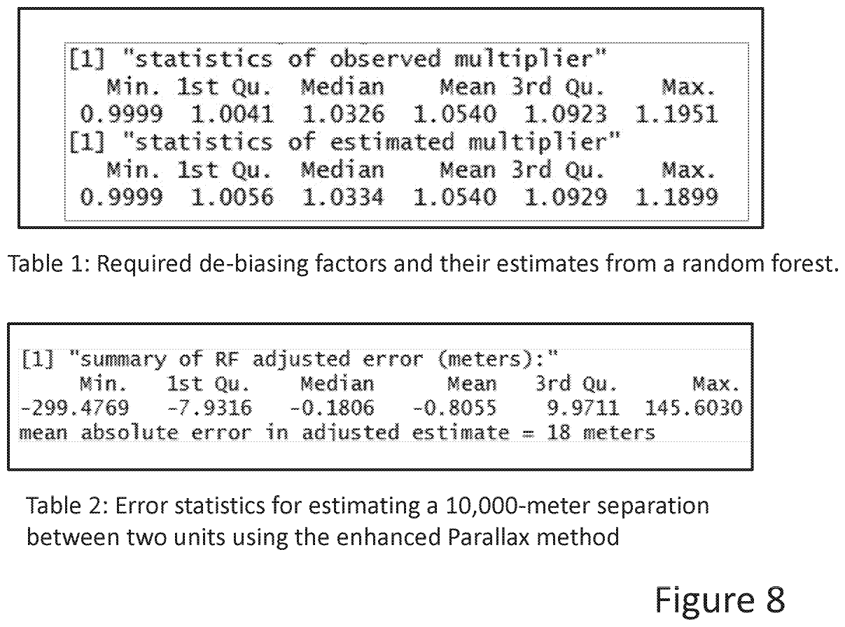

That this approach is successful can be seen in the following example. First, Table 1 in FIG. 8 shows that the random forest successfully converts its training data into estimates of how the estimates from new scenarios should be de-biased. The random forest estimates the correction factor (“multiplier”) by analyzing data from a very large number of simulated scenarios of the type shown in FIG. 6. That the estimated summary statistics of the debiasing factors closely match those required is clear from the summary statistics presented in Table 1.

The enhanced estimates provide useful answers. Table 2 in FIG. 8 shows that the average error in estimating a 10-kilometer distance is less than 1 meter, and half the time the error is 18 meters or less. It is important to note that the scenario generating these examples assumed only 10 strokes generated by two storms. There are almost always more than two active storms that can be exploited at transcontinental distances, and results improve with both the number of storms and the number of TDOA values derived from them.

The enhanced parallax process generally includes: training a model on simulated scenarios of lightning storms, wherein the model is trained with parallax estimates for each simulated scenario; obtaining TOA information; computing TDOA information from the TOA information; converting TDOA information to distance estimates; and correcting the distance measurements with the model to generate a distance from the local mobile unit to the remote mobile unit.

In one illustrative approach, the parallax method may be implemented as follows:

1. Simulate a large number N of simulated scenarios having various numbers of active storms generating various numbers of strokes per storm and various distances between units.

2. Compute the simple parallax estimates for each simulated scenario and the ratio of the true unit separation to the simple estimate, which is the required correction factor for de-biasing the estimates.

3. Select key summary statistics of the estimates (e.g., standard deviation) for use as inputs to a random forest model that will estimate the required correction factors.

4. Train a random forest (or similar machine learning model) on the scenarios.

5. Record the differences between the estimates from the random forest and the values used in the scenarios to get an estimate of the expected error.

6. Obtain real-world Time of Arrival (TOA) values for multiple lightning strokes as observed at each unit.

7. Compute the Time Difference of Arrival (TDOA) for each stroke as the difference between the two TOA's.

8. Convert the TDOAs to distance estimates by multiplying them by the speed of light.

9. Correct those estimates by inputting their summary statistics into the pre-computed random forest, then multiplying the predicted correction factor by the simple estimates.

10. Add margins of error to the distance estimates to provide a hedge for sampling variability.

### Detection System

### a. Embodiment 1

As noted, a further challenge in implementing geolocation system 10 involves the ability to identify a relevant signal from collected EM signals. In one illustrative embodiment, the signal strength meter (S-meter) in a software defined radio (SDR), or the like, may be used that measures the strength of the signal detected by the antenna. A challenge in detecting a lightning stroke, which may have occurred hundreds or thousands of miles away, is to distinguish the stroke's signal from random background noise.

Two illustrative techniques are provided for detection of a lightning stroke from received EM signals. The first technique sums the signal energy at each of a range of frequencies into a single time series of signal strength, as for example generated by a signal-strength S-meter in many frequency scanners and SDRs. The second technique parallel-processes the signal strengths at all individual frequencies within a range, as provided, e.g., by a spectral plot generated by many SDRs.

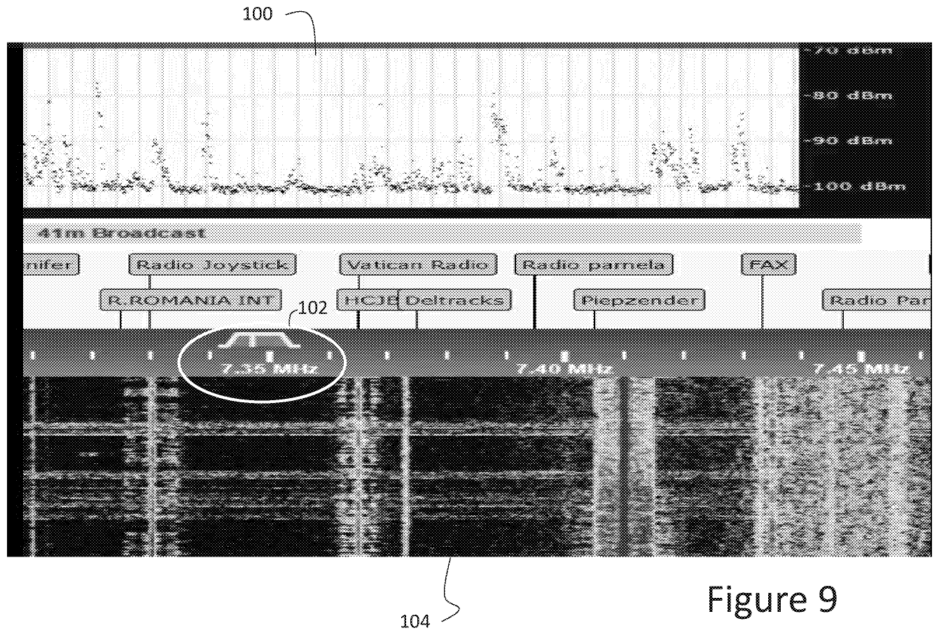

FIG. 9 depicts an interface that illustrates both approaches. The upper panel 100 illustrates an S-meter signal computed over the frequency range marked by the circle 102 in the bottom panel (roughly 7.34 MHz to 7.36 MHz). The lower panel 104 is the spectral plot over a wider range of frequencies (7.31 MHz to 7.46 MHz). In the spectral plot, frequency is shown horizontally and time flows downward. Bright vertical lines depict signals from fixed transmitters (e.g., Radio Joystick, Vatican Radio, etc); bright horizontal lines depict the energy from lightning strokes, which radiate at a very wide range of frequencies.

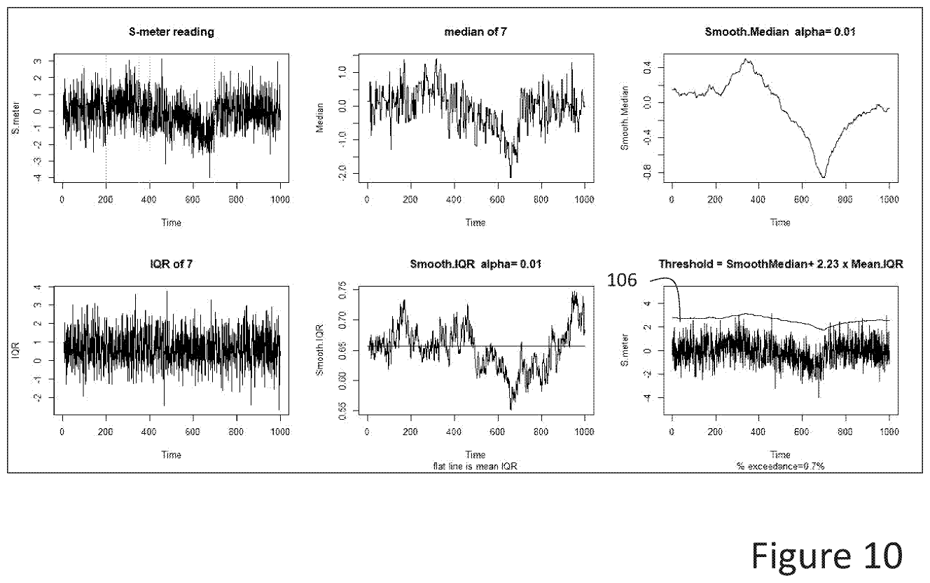

In a realization using signal strength, as reflected in the S-meter plot, to mark the instant at which the lightning signal hits the antenna 22, the frequency scanner 14 computes a floating threshold above the background level which, when crossed, marks the moment of arrival. FIG. 10 illustrates this approach, in which computing the threshold 106 (shown in the bottom right panel) is similar to determining an Upper Control Limit in statistical process control (SPC). However, this case differs from SPC in important ways: the lightning signals often appear in clusters not singly, the spikes from the lightning will distort the traditional use of the mean and standard deviation for characterizing the background noise, the mean level of background noise will often “float” as a result of changes in propagation conditions, and man-made signals may appear on frequency as additional spikes.

In the realization using an S-meter, the man-made signals may be filtered out by requiring simultaneous detection at two or more properly separated frequencies, since lightning signals appear simultaneously at a very wide range of frequencies. The influence of the lightning spikes on the level and spread of the background noise can be minimized by replacing the signal's mean strength with the median of a moving window of several consecutive observations (upper middle plot of FIG. 10) and replacing the signal strength's standard deviation with the interquartile range (IQR) within the same window (lower left plot). The drift of “float” in the mean can be tracked by applying exponential smoothing to the sequence of medians of the windowed S-meter values (lower middle plot). Then a floating threshold can be computed at each time interval (lower right plot) by adding a chosen multiple of the average IQR to the smoothed value of the running median. The multiple used will control the number of false positive and false negative errors in the determination of whether a blip in the S-meter plot indicates a lightning stroke.

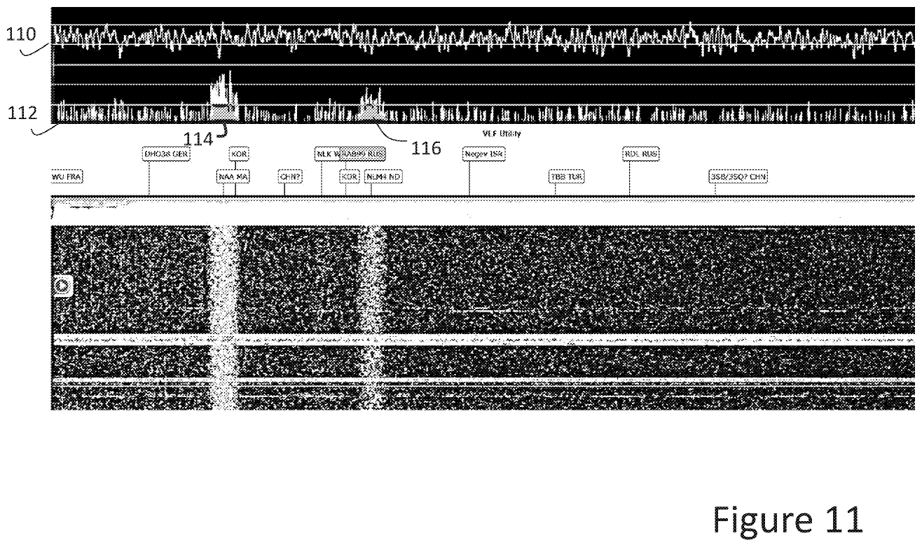

In the realization using the spectral plot, the components of the S-Meter signal at individual frequencies are displayed individually rather than summing them. FIG. 11 depicts two forms of spectral display, a spectral plot above and a waterfall plot below.

The top panel of FIG. 11 shows a spectral plot, with frequency plotted horizontally and signal strength plotted vertically. The lower part 112 of the spectral plot displays mostly short spikes of random length, corresponding to random background “static” at their corresponding frequences. In this example, there is a strong transmitter signal 114 at 24 kHz and a weaker signal 116 at 25.2 kHz. Upper line 110 records the largest signal strength observed at each frequency over the current period of data collection. The gap between 110 and 112 documents the impact of the most powerful lightning stroke that occurred during the recording period. This difference is the basis the embodiment discussed next.

The bottom panel is a waterfall plot, a three-dimensional display with frequency plotted horizontally, time plotted vertically, and signal strength indicated by color/intensity. In the waterfall plot, the two transmitters display as bright vertical bands and two lightning strokes display as bright horizontal bands. The second stroke (shown higher in the bottom plot, since time flows downward) was especially strong.

To implement TOA calculations in real time, the above concepts can be implemented in hardware (e.g., with an Application-Specific Integrated Circuit (ASIC) device, a Field-Programmable Gate Arrays (FPGAs), or the like). The basic principle is to mark the moment when the signal strengths at multiple frequencies simultaneously jump up to levels well beyond their usual random fluctuations. In turn, this requires: (a) Choosing a threshold value for each frequency. This can be accomplished using a “floating threshold” as described above. (b) Choosing a number of frequencies to monitor. A larger number reduces the odds of a spurious terrestrial transmission being mislabeled as lightning. (c) Choosing a decision rule, i.e., a “majority vote”, for concluding that a stroke has occurred.

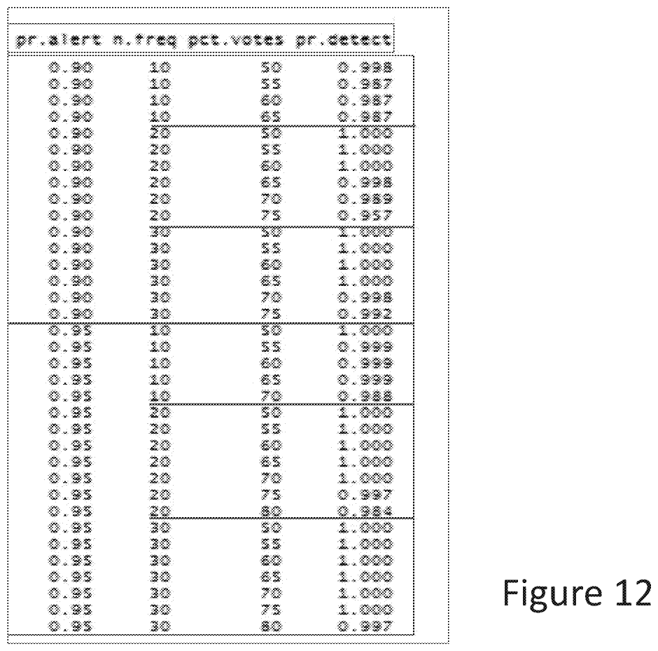

For example, suppose the detection system monitors ten well-separated frequencies. If only one frequency “alerts” to the presence of lightning, we may well regard this as a statistical anomaly and choose not to react. But requiring all ten to alert may be too cautious, since a quirky failure at just one frequency would cause the system to miss the event. Accordingly, a rule like “8 out of 10” may be used, but the best choice involves tradeoffs best made by the system user. Cost and power usage considerations would also enter into this determination. FIG. 12 shows simulation results relating the probability of successfully detecting a stroke to the threshold level, the number of frequencies, and the voting rule. To keep all the parallel processing aligned in time, all intermediate frequence (IF) filters must be calibrated to have equal processing delay.

The final calculation of inter-unit distance would involve the exchange of observed TOAs at each unit, followed by their subtraction to obtain the TDOA, then division by the speed of light to produce a final estimate of the distance. Implicit in this approach is that the clocks at each unit are both sufficiently fast to distinguish small time intervals and that they two clocks are sufficiently synchronized.

Note that since the response time of each receiver on different mobile units will be affected by the intermediate frequency (IF) bandwidth and detector output filtering, a calibration system may be included to ensure that the internal receiver delays are equal in all of the receivers. Since it is not practical to have a receiver with a bandwidth equivalent to the lightning signal itself, and a narrower bandwidth is a compromise which creates a delay from the input signal to detector output, such a calibration system ensures that this delay is identical over all receivers, preventing the system from incorrectly identifying the exact time of the stroke. Knowing the calibrated delay in all receivers allows the system to compensate for that delay, providing accurate timing information.

### Beacons

As noted, man-made signals (i.e., beacons) can be exploited as complements (and sometimes substitutes) for lightning signals. “Beaconing,” e.g., provides geolocation based on the azimuth or bearing from a mobile unit or platform to a fixed terrestrial transmitter. In one illustrative embodiment, beacons can be used instead of lightning to provide TOA information to geolocate other remote mobile units as described above. In a further embodiment, beacons can be used to provide an absolution location of the local mobile unit.

Beaconing can for example use the classic navigation method of triangulation, in which geolocation based on optical sightings of known fixed points (e.g., a mountain top) is replaced by radio-based navigation. Estimating the azimuth can be done in any number of ways, e.g., using intra-unit time difference of arrival methods with two or more receiver/antenna pairs mounted on the unit, using signal strength comparisons using one or more rotatable antennas, etc.

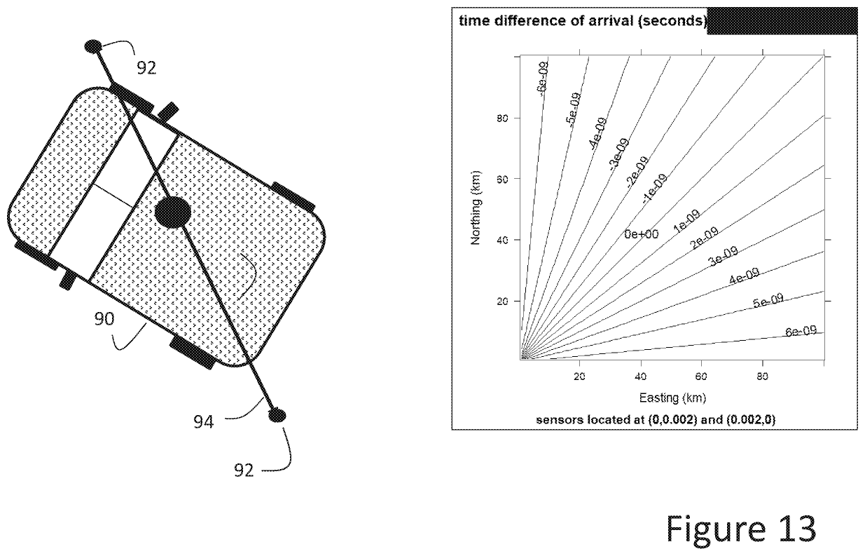

The left side of FIG. 13 illustrates a mobile unit 90 with two antennas 92 installed on a boom 94. In this example, mobile unit 90 is shown with two antennas separated by 2.8 meters, feeding into a receiver with a clock available to timestamp the times of arrival of the beacon signals. Except for the small chance that the axis connecting the antennas is exactly perpendicular to the azimuth, a signal from a beacon will arrive at slightly different times at the two antennas, creating an intra-unit time difference of arrival (ITDOA). Provided that the clock timing the moments of arrival of the beacon signal at the antennas 92 is sufficiently fast, the ITDOA will map directly into an azimuth, so that a bearing can be estimated without moving the antennas. Given azimuths to two beacons with known fixed locations, the receiver's absolute location can be determined by triangulation, i.e., by computing the point of crossing of the two lines drawn from the unit location to the published beacon coordinates. Sighting on more beacons and averaging the results further improves accuracy.

The right side of FIG. 13 shows the intra-unit time differences of arrival of signals coming from various angles to an antenna, and whose TDOA's are computed. The figure makes clear how TDOA data can be converted to azimuth estimates. It also makes clear how a finite clock speed combines with a small antenna closer antennas to introduce ambiguity in the estimate of the angle from unit to a detected signal.

The nature of the beacon signal is important. If the beacon simply broadcasts a constant signal, there is no signal reception event to timestamp at a TOA, and this method cannot be used for geolocation. However, many beacons provide time-varying signals that are subject to TDOA analysis. Many nondirectional navigation beacons (NDBs) near airports generate an identifier in Morse code. Other beacons broadcast time signals similar to a ticking clock.

Even non-beacons can be treated as beacons. For example, submarines intermittently receive messages from stations operating in the VLF frequency range. These stations use massive antennas positioned at known coordinates. By tuning a receiver in a certain way, the resulting signals have irregular peaks that become the functional equivalent of lightning strokes.

At any given time from any specific location, signals from a number of beacons may be available for exploitation. Since the receiver will have to be re-tuned to switch from one beacon frequency to another and then time must be taken to receive and process the signals, the geolocation system 10 needs to select a subset of beacons for use. In various cases, this selection may need to be made as quickly as possible, since the motivation for geolocation may be to urgently move a remote mobile to a new location. For instance, if a dozen beacons are accessible to a unit, it may be necessary to select a subset of three to use in triangulation.

Selecting the best subset from a larger group is a problem in combinatorial optimization. Selecting 3 beacons from a set of 12 is a problem with 220 possible answers. A discrete optimization algorithm to do the job would require an objective function that is to be minimized or maximized, such as “achieve the lowest error in the unit's estimated position”. It would also require constraints on the nature of the solutions, such as “use no more than 4 beacons” (simulations show decreasing returns to scale as more beacons are involved).

Alternatively, heuristics might be used to speed up the decision algorithm, such as “select beacons from as many possible quadrants around the unit's presumed position”. Development of the heuristics would be aided by spatial Monte Carlo simulations.

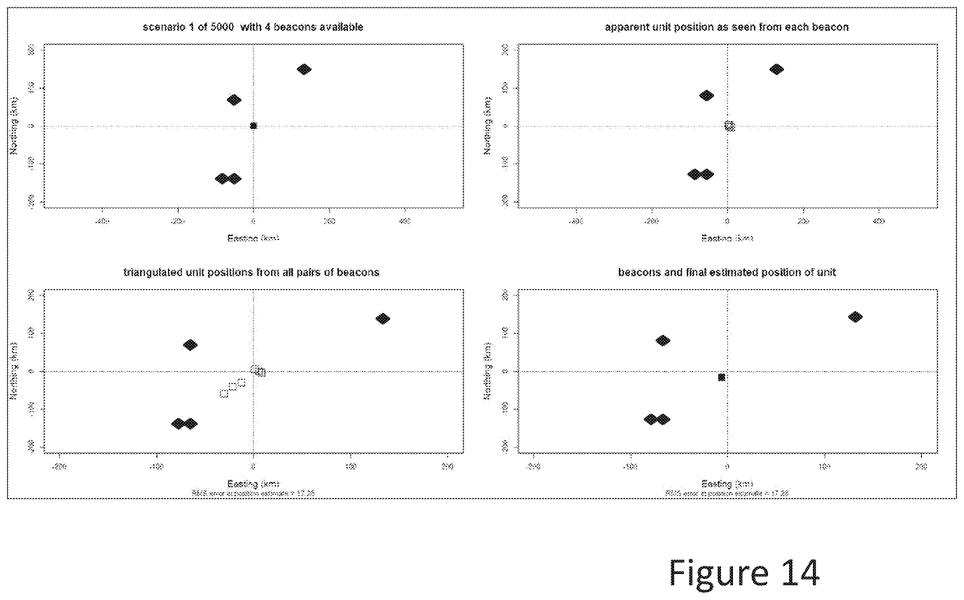

FIG. 14 depicts such a simulation. The top left panel depicts one unit surrounded by four beacons (shown as diamonds) occupying three quadrants of the area around the unit. The top right panel depicts the apparent location of the unit (shown as overlapping squares) as “seen” by each beacon, illustrating how random error in measured azimuth from beacon to unit results in about a 5 kilometer uncertainty in unit position. The bottom left panel plots the six estimated locations of the unit (shown as squares) based on triangulation using all six pairs of beacons. Finally, the bottom right panel shows the average of the six estimates, the final answer, which is in error by about 17 km in this particular scenario. Five thousand such simulations show that the mean error decreases from about 8.90 km to 7.04 to 5.89 to 5.44 as the number of quadrants around the unit having one or more beacons increases from one to two to three to four. Finer-grained spatial analysis would encode more precise estimates in the decision algorithm.

Design of antenna systems may require choices of antenna size and shape and separation versus the speed the clocks used to calculate ITDOA data. Smaller antenna separation must be traded off against clock speed. Closer antenna pairs decrease the physical profile of the unit and make it less likely to be detected. But it also requires a faster clock to make the finer temporal distinctions required of ITDOA's based on shorter paths.

The ability to exploit both lightning and beacons provides flexibility but creates the need for a decision aid to guide the system and/or user to the best choice of modality. As noted, a selector 16 may be provided that constantly monitors relevant conditions and opportunities and then directs the computation of the appropriate action. The decision of how best to geolocate can be complicated and is constantly shifting, depending strongly on time and location. For example, VLF or HF radio propagation conditions are always in flux. They vary somewhat systematically by location, time of day and season but are also influenced by random factors such as solar flares. Lightning itself has spatio-temporal randomness along with systematic influences like time of day, season, and location. Some beacons operate only during certain hours or irregularly. Some beacons may be off the air for maintenance. Some beacons' signals may be undetectable because their frequency is not favored by the propagation conditions of the moment.

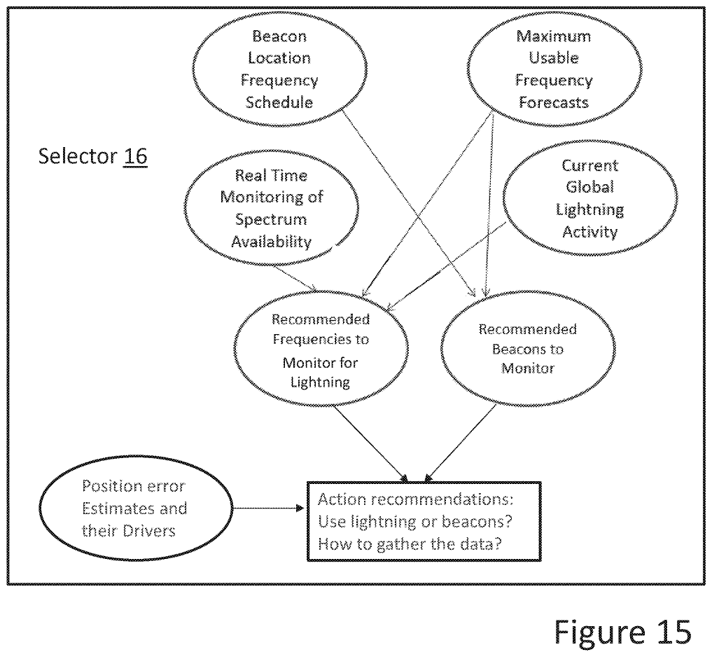

FIG. 15 depicts various process flows that may occur by selector 16. Factors to consider may include beacon location and frequency schedule, maximum usable frequency (MUF) forecasts, real time monitoring of spectrum availability, and current global lightning activity. Based on these factors, recommended frequencies to listen for lightning or recommended beacons to monitor may be determined. From this, as well as from position error estimates and their drivers, selector 16 would provide automated recommendations such as whether to use lightning or beacons, how to gather data, etc.

The geolocation system 10 (FIG. 1) may include the following various capabilities:

Database maintenance. Relevant data would include the operating schedules and frequencies of all beacons potentially useful in the unit's area of responsibility (AOR); the current and projected maximum usable frequency (MUF) at each place on the planet; space weather forecasts of solar flare activity that might impede radio propagation at certain frequencies; other such datasets that are currently publicly available; and classified datasets not listed here.

Lightning monitoring. System 10 would constantly monitor global lightning activity, whether the units were deployed or at their home base. Examples of lightning stroke information is provided at www.lightningmaps.org.

Spectrum monitoring. System 10 must identify at least two frequencies for the SDR to monitor to detect the timing of lightning signals. These choices must be constantly reviewed, not just to respond to shifts in radio propagation conditions but also because any single frequency might suddenly be occupied by a transmitter, be it a pirate radio station or simply one in intermittent use, e.g., a fax machine in Japan.

Estimation of system accuracy. These would include estimating the uncertainty in TDOA values and in bearings used in direction finding. Statistical best practice is to never provide an operator with an estimated result without an accompanying estimate of its margin of error.

Selection of method of geolocation. System 10 could also perform ranking and selection calculations for beaconing. By comparing and/or combining position estimates from TDOA and beaconing calculations, selector 16 will automatically choose the best information to exploit.

Geolocation computations. In certain cases, system 10 may compute an absolute location of units, in other cases, it will compute relative positions of units with respect to each other. Additionally, system 10 may combine the TDOA and bearing data of units to estimate the unit's location.

Reporting of results. System 10 will present its position estimates to its own unit and transmit them by secure means (e.g., encrypted burst transmission) to companion units. The presentation might be a straightforward text display, a graphical display, or an overlay on a tactical display already in the unit, such as an IBCS terminal in an armored vehicle.

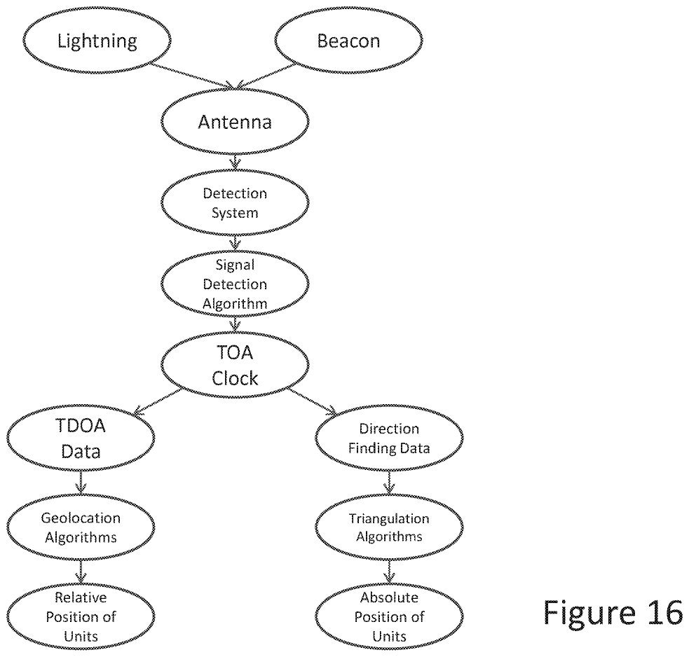

FIG. 16 depicts a further illustrative flow diagram of processing. As shown, lightning and/or beacon data are captured by an antenna and the signals are processed by a detection system. A signal detection algorithm detects lightning signals, which is further processed by a clock to determine TOA data and/or direction-finding data. In one case, TDOA data is fed into a geolocation algorithm to generate relative positions of units with respect to each other. In another case, direction finding data is processed by triangulation algorithms to provide absolution positioning of the units.

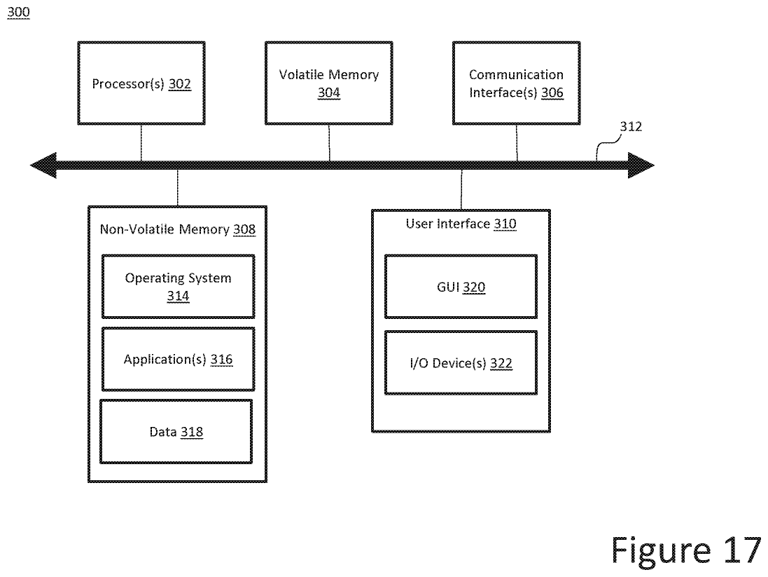

Elements of the described solution may be embodied in a computing system, such as that shown in FIG. 17 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 17 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

What is claimed is:

1. A geolocation system for a local mobile unit, comprising:
a receiver coupled to an antenna and configured to receive electromagnetic (EM) signals;
a system for recommending at least one frequency to monitor;
a detection system for detecting a lightning stroke from the EM signals based on the at least one frequency;
a system for determining local time of arrival (TOA) information for the lightning stroke;
a transceiver for receiving remote TOA information from a remote mobile unit; and
a geolocation algorithm that calculates time difference of arrival (TDOA) information from the local TOA information and remote TOA information and generates geolocation results of the remote mobile unit based on the TDOA information.

2. The geolocation system of claim 1, wherein the detection system is further configured to detect a man-made beacon, and the system for determining local TOA information determines TOA information for the man-made beacon.

3. The geolocation system of claim 1, wherein the antenna comprises a directional antenna that provides directional information.

4. The geolocation system of claim 1, wherein the system for determining local TOA information utilizes an Oven Controlled Crystal Oscillator (OCXO) clock.

5. The geolocation system of claim 1, wherein the geolocation algorithm determines a relative location of the remote mobile unit and is implemented according to a process that includes:
obtaining TOA information for two lightning strokes at both a local mobile unit and a remote mobile unit, wherein the TOA information includes directional information for each lightning stroke;
calculating TDOA information for both lightning strokes;
choosing distance values from the local mobile unit to each of the two lightning strokes;
estimating a location of each lightning stroke based on the distance values and directional information;
constructing a pair of circles around estimated locations of the two lightning strokes;
determining an estimated location of the remote mobile unit based on an intersection of the pair of circles; and
revising the distance values and repeating the estimating, constructing, determining steps until a converged solution is obtained.

6. The geolocation system of claim 1, wherein the geolocation algorithm determines a location of the remote mobile unit and is implemented according to a parallax process that includes:
training a model on simulated scenarios of lightning storms, wherein the model is trained with parallax estimates for each simulated scenario;
obtaining TOA information;
computing TDOA information from the TOA information;
converting TDOA information to distance estimates; and
correcting the distance measurements with the model to generate a distance from the local mobile unit to the remote mobile unit.

7. The geolocation system of claim 1, wherein the detection system for detecting a lightning stroke is implemented according to process that includes calculating a signal strength threshold and detecting a lightning stroke for a captured signal above the signal strength threshold.

8. The geolocation system of claim 1, wherein the receiver coupled to the antenna comprises a very low frequency (VLF) receiver and VLF antenna.

9. The geolocation system of claim 8, wherein the transceiver comprises a high frequency (HF) transceiver coupled to a HF antenna.

10. The geolocation system of claim 2, further comprising:
a pair of spaced antennas, each configured to obtain an intra-unit TOA;
a system for calculating an intra-unit TDOA (ITDOA) from the pair of intra-unit TOAs; and
a system for determining directional data from the ITDOA.

11. The geolocation system of claim 1, wherein the system for recommending at least one frequency to monitor includes a frequency scanner.

12. The geolocation system of claim 2, further comprising a selector system for selecting between using lightning strokes and man-made beacons.

13. The geolocation system of claim 2, further comprising a beacon database that includes beacon transmitter information.

14. The geolocation system of claim 2, further comprising a subsystem that uses TOA information from man-made beacons to triangulate an absolute location of the local mobile unit.

15. A method for determining geolocation location of a remote mobile unit from a local mobile unit, comprising:
recommending at least one frequency to monitor;
monitoring electromagnetic (EM) signals at the at least one frequency with a receiver coupled to an antenna;
detecting a lightning stroke from the EM signals based on the at least one frequency;
determining local time of arrival (TOA) information for the lightning stroke;
receiving remote TOA information for the lightning stroke from the remote mobile unit; and
calculating time difference of arrival (TDOA) information from the local TOA information and remote TOA information and generating geolocation results of the remote mobile unit based on the TDOA information.

16. The method of claim 15, further comprising:
providing a selector to detect a man-made beacon;
determining local TOA information from the man-made beacon;
receiving remote TOA information; and
calculating time difference of arrival (TDOA) information from the local TOA information and remote TOA information and generating geolocation results of the remote mobile unit based on the TDOA information.

17. The method of claim 15, wherein the geolocation results determine a relative location of the remote mobile unit according to a process that includes:
obtaining TOA information for two lightning strokes at both a local mobile unit and a remote mobile unit, wherein the TOA information includes directional information for each lightning stroke;
calculating TDOA information for both lightning strokes;
choosing distance values from the local mobile unit to each of the two lightning strokes;
estimating a location of each lightning stroke based on the distance values and directional information;
constructing a pair of circles around estimated locations of the two lightning strokes;
determining an estimated location of the second mobile unit based on the intersection of the pair of circles; and
revising the distance values and repeating the estimating, constructing, determining steps until a converged solution is obtained.

18. The method of claim 15, wherein the geolocation results determine a location of the remote mobile unit according to a process that includes:
training a model on simulated scenarios of lightning storms, wherein the model is trained with parallax estimates for each simulated scenario;
obtaining TOA information;
computing TDOA information from the TOA information;
converting TDOA information to distance estimates; and
correcting the distance estimates with the model to generate a distance from the local mobile unit to the remote mobile unit.

19. The method of claim 15, wherein the antenna comprises a directional antenna that provides directional information.

20. The method of claim 15, wherein determining local TOA information utilizes an Oven Controlled Crystal Oscillator (OCXO) clock.
